(19) United States
(12) Patent Application Publication
(10) Pub. No.: US 2025/0045380 A1
(43) Pub. Date: Feb. 6, 2025

(54) SYSTEMS AND METHODS FOR DETECTING EVIDENCE OF TAMPERING IN A DOCUMENT

(71) Applicant: Wells Fargo Bank, N.A., San Francisco, CA (US)

(72) Inventors: Rameshchandra Bhaskar Ketharaju, Hyderabad (IN); Brajraj Brajraj, Bengaluru (IN); Ramamohan S, Hyderabad (IN); Rohin Khanna, Bengaluru (IN)

(21) Appl. No.: 18/365,078

(22) Filed: Aug. 3, 2023

(51) Int. Cl. G06F 21/55

(52) U.S. Cl. CPC G06F 21/552; G06F 2221/034

(57) ABSTRACT

Systems, apparatuses, methods, and computer program products are disclosed for detecting evidence of tampering in a digital document. An example method includes receiving by communications hardware, the digital document and determining, by tampering detection circuitry, a tampered region classification result for a region of the digital document. The example method further includes in an instance in which the tampered region classification result indicates tampering, providing, by the tampering detection circuitry, an indication of the region of the digital document and the tampered region classification result to a combination model and receiving, by the tampering detection circuitry, an overall tampering probability from the combination model.

### BACKGROUND

Digital documents have provided great benefits for effectively storing copies of large numbers of documents. Digital documents are now ubiquitous in society, and therefore it is necessary in all industries to work with them. However, digital documents exhibit various issues and shortcomings.

### BRIEF SUMMARY

Digital documents are useful for storing records (e.g., customer records, customer applications, or the like). However, digital documents are exposed to unique risks of tampering that do not exist for paper documents, given that they are often easily accessed from anywhere in the world, and tampering can be done without being easily identifiable (unlike physical documents for which alterations are often readily apparent). In this regard, thoughtful tampering detection techniques (anti-tampering detection techniques) are required to ensure the authenticity, integrity, and reliability of digital documents.

Entities that collect and store digital documents may implement an anti-tampering detection technique to investigate the authenticity of a document. Anti-tampering techniques may include active tamper detection techniques, such as comparison to a template document and/or comparison to a previous version of the document, and passive tamper detection techniques, such as a linear binary pattern (LBP) methodology, single value decomposition (SVD), double blurring correlations, or the like, which do not require historical data (e.g., a template, prior version of a document, or the like).

While a singular anti-tampering technique may detect evidence of tampering, current implementations of anti-tampering techniques have blind spots that limit their ability for detecting evidence of tampering. For example, LBP-based tampering detection techniques may be adept at detecting certain types of tampering, such as copy-pasting, insertion, and deletion of text and/or images, however, LBP may struggle with detecting evidence of more sophisticated tampering techniques, such as image retouching or image blending. In another example, double blurring correlation methods utilize blurring filters to blur a document; however, the reliability of double blurring correlation methods to detect evidence of tampering is dependent on the types of blurring filters used (e.g., gaussian filter, median filter, or the like).

Example embodiments alleviate the issues discussed above by combining active and passive tampering detection techniques to provide a comprehensive digital document tamper detection solution. To do so, some example embodiments may leverage a plurality of models to deploy multiple anti-tampering techniques in conjunction, as further discussed herein. Example embodiments may, receive a digital document. In addition, example embodiments may determine a tampered region classification result for a region of the digital document. For example, a passive tamper detection engine may determine a passive tampered region probability for a region of the digital document. Further, the passive tampered region probability may be determined by generating a grayscale version of the digital document, extracting one or more features associated with the grayscale version of the digital document, applying a principal component analysis to remove redundancy of the features, generate a subset of features following redundancy removal, and apply a hyperplane to the subset of features to produce a detection result.

Example embodiments may also determine whether the digital document is associated with a standard data template. In addition, if the digital document is associated with a standard data template, example embodiments may determine an active tampered region probability for a region of the digital document. For example, a set of red, green, and blue (RGB) values associated with the digital document may be extracted and compared to a historical set of RGB values to determine the age of the document and account for aging characteristics, such as blurring of the image, brightness changes, color reduction, or the like.

If a digital document is associated with the standard data template, example embodiments may also determine whether a unique digital marker is associated with the digital document. For example, the standard data template may be searched for an indicator of a unique digital marker, such as a digital watermark, digital signature, or the like. In addition, if the standard data template is associated with the unique digital marker, example embodiments may identify the unique digital marker embedded in the digital document, extract the unique digital marker, and determine a probability of authenticity by analyzing the unique digital marker. Furthermore, if a digital document is associated with a standard data template, example embodiments may determine a structural similarity index associated with the digital document and the standard data template. In addition, example embodiments may generate a structural similarity tampering probability based on the determined structural similarity index.

Example embodiments may also provide an indication of a region of the digital document and the tampered region classification result to a combination model. In addition, example embodiments may receive an overall tampering probability from the combination model. Example embodiments may also determine a tampering confidence result based on the overall tampering probability. For example, an overall tampering probability of 0.60 (e.g., 60%) may be assigned a tampering confidence result of “likely tampered” based on a tampering threshold describes overall tampering probabilities between 0.55 and 0.75 to be categorically sorted into a tampering confidence result of “likely tampered”. Accordingly, the present disclosure sets forth systems, methods, and apparatuses that efficiently detect evidence of tampering in digital documents.

There are many advantages of the tamper-detection concepts described herein. For instance, a blend of passive and/or active tampering detection techniques may detect evidence of tampering associated with a digital document that may not be identified by conventionally performing a singular anti-tampering detection technique on the digital document. In addition, some example embodiments are able to combine a variety of partial tampering probabilities resulting from a plurality of anti-tampering techniques to determine an overall tampering probability associated with a digital document that is more reliable than any of the individual tampering probabilities. Further, some example embodiments increase efficiency by automatically processing digital documents that include unique digital markers (e.g., digital signatures, digital watermarks, or the like), rather than manually selecting an anti-tampering technique to evaluate a unique digital marker. Thus, example embodiments enhance capabilities of existing tamper detection techniques by combining an ensemble of partial tampering probabilities produced by an ensemble of passive and/or active anti-tampering techniques and by automatically processing digital documents that have a unique digital marker.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a system device that may perform various operations in accordance with some example embodiments described herein.

FIG. 3 illustrates an example flowchart for detecting evidence of tampering in digital documents, in accordance with some example embodiments described herein.

FIG. 4 illustrates another example flowchart for using a passive tamper engine for detecting evidence of tampering, in accordance with some example embodiments described herein.

FIG. 5 illustrates an example flowchart for using an active tamper detection engine for detecting evidence of tampering, in accordance with some example embodiments described herein.

FIG. 6 illustrates an example flowchart for using a digital document's historical red, green, and blue data to detect evidence of tampering, in accordance with some example embodiments described herein.

FIG. 7 illustrates another example flowchart for using a unique digital marker for determining a probability of authenticity associated with the digital document, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

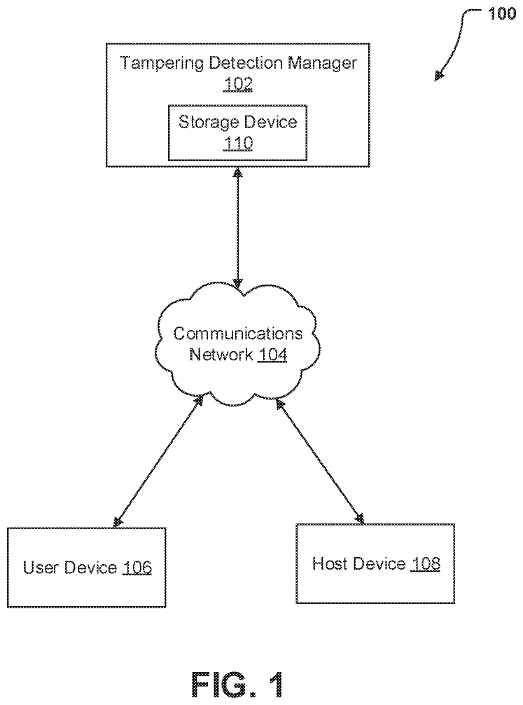

Example embodiments described herein may be implemented using any of a variety of computing devices or servers. To this end, FIG. 1 illustrates an example environment 100 within which various embodiments may operate. As illustrated, a tampering detection manager 102 may receive and/or transmit information via communications network 104 (e.g., the Internet) with any number of other devices, such as user device 106 and/or host device 108.

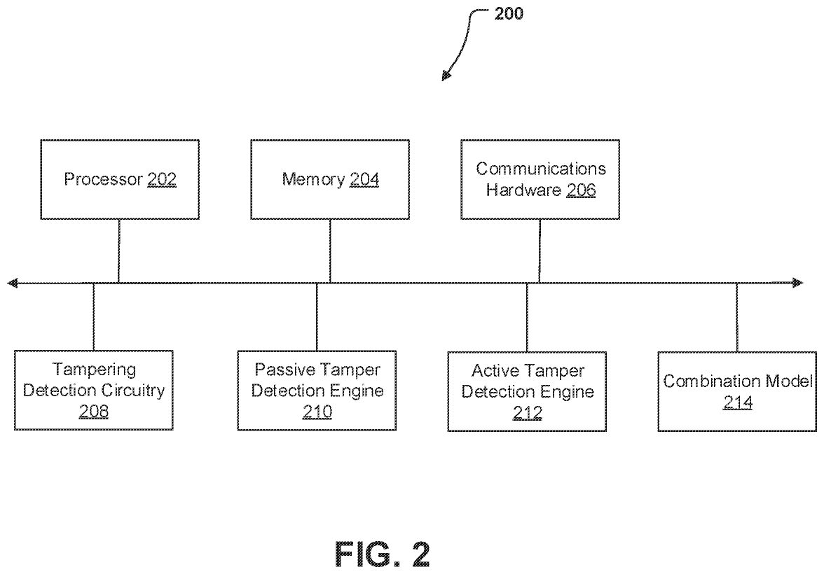

The tampering detection manager 102 may be implemented as one or more computing devices or servers, which may be composed of a series of components. Particular components of the tampering detection manager 102 are described in greater detail below with reference to apparatus 200 in connection with FIG. 2.

In some embodiments, the tampering detection manager 102 further includes a storage device 110 that comprises a distinct component from other components of the tampering detection manager 102. Storage device 110 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Storage device 110 may host the software executed to operate the tampering detection manager 102. Storage device 110 may store information relied upon during operation of the tampering detection manager 102, such as various algorithms that may be used by the tampering detection manager 102, data and documents to be analyzed using the tampering detection manager 102, or the like. In addition, storage device 110 may store control signals, device characteristics, and access credentials enabling interaction between the tampering detection manager 102 and user device 106 or host device 108.

The user device 106 may be embodied by any computing device known in the art, such as a desktop computer, laptop computer, smartphone, smart devices (e.g., a smart printer), or the like. Similarly, host device 108 may be embodied by any computing device known in the art, such as desktop or laptop computers, or the like that are managed by an entity (e.g., a financial institution). The user device 106 and host device 108 need not themselves be independent devices, but may be peripheral devices communicatively coupled to other computing devices.

Although FIG. 1 illustrates an environment and implementation in which the tampering detection manager 102 interacts indirectly with a user via user device 106 and/or host device 108, in some embodiments users may directly interact with the tampering detection manager 102 (e.g., via communications hardware of the tampering detection manager 102), in which case a separate user device 106 and/or host device 108 may not be utilized. Whether by way of direct interaction or indirect interaction via another device, a user may communicate with, operate, control, modify, or otherwise interact with the tampering detection manager 102 to perform the various functions and achieve the various benefits described herein.

### Example Implementing Apparatuses

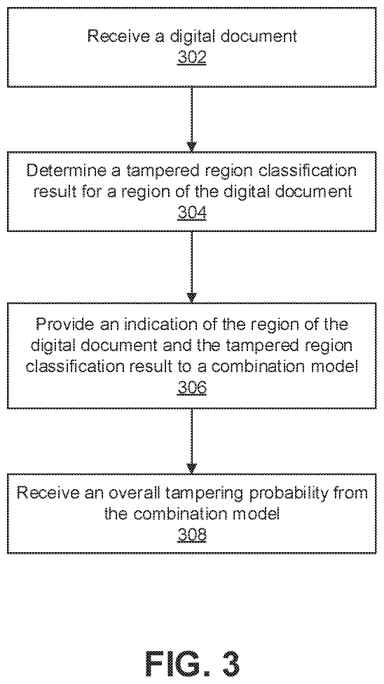

The tampering detection manager 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-7. As illustrated in FIG. 2, the apparatus 200 may include processor 202, memory 204, communications hardware 206, tampering detection circuitry 208, passive tamper detection engine 210, active tamper detection engine 212, and combination model 214 each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a tampering detection circuitry 208 configured to determine a tampered region classification result for a region of the digital document and, based upon a predetermined threshold, provide an indication of the region of the digital document and the tampered region classification result to combination model 214. In addition, the tampering detection circuitry 208 is configured to receive an overall tampering probability from the combination model. The tampering detection circuitry 208 may utilize processor 202, memory 204, or any other hardware component included in the apparatus 200 to perform these operations, as described in connection with FIGS. 3-7 below. The tampering detection circuitry 208 may further utilize communications hardware 206 to gather data from a variety of sources (e.g., user device 106 and/or host device 108 as shown in FIG. 1), and/or exchange data with a user, and in some embodiments may utilize processor 202 and/or memory 204 to perform any or more of the above operations.

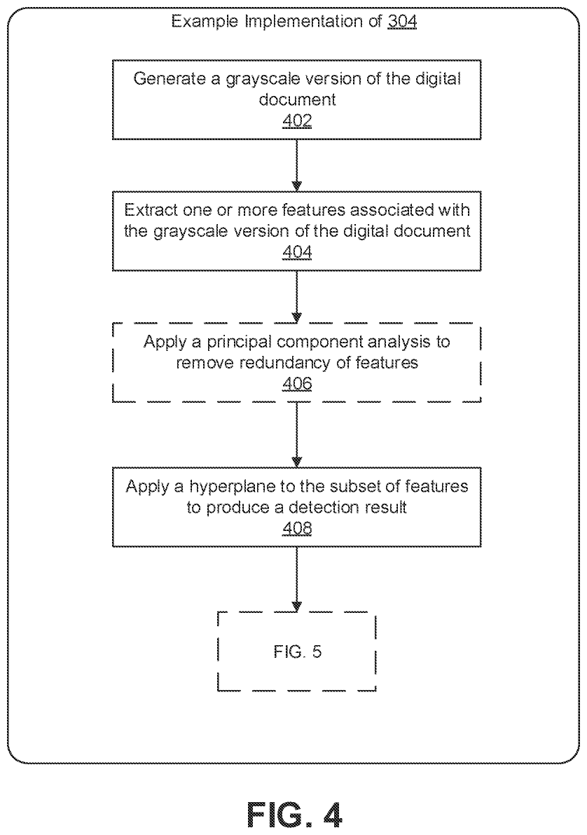

In addition, the apparatus 200 further comprises a passive tamper detection engine 210 configured to determine a passive tampered region probability for a region of the digital document. The passive tamper detection engine 210 may utilize processor 202, memory 204, or any other hardware component included in the apparatus 200 to perform these operations, as described in connection with FIG. 4 below. In some embodiments, the passive tamper detection engine 210 may comprise a plurality of engines that perform a variety of passive tamper detection techniques. In other embodiments, the passive tamper detection engine 210 may comprise a single engine that performs a variety of passive tamper detection techniques. The passive tamper detection engine 210 may further utilize communications hardware 206 to gather data from a variety of sources (e.g., user device 106, host device 108, or the like), and/or exchange data with a user, and in some embodiments may utilize processor 202 and/or memory 204 to perform any or more of the above operations.

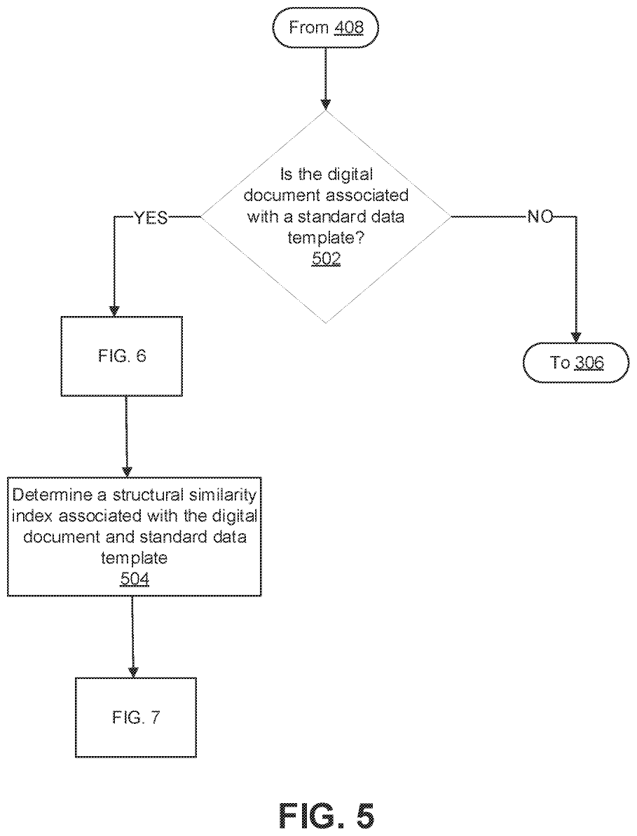

In addition, the apparatus 200 further comprises an active tamper detection engine 212 configured to determine an active tampered region probability for a region of the digital document. The active tamper detection engine 212 may utilize processor 202, memory 204, or any other hardware component included in the apparatus 200 to perform these operations, as described in connection with FIG. 5 below. In some embodiments, the active tamper detection engine 212 may comprise a plurality of engines that perform a variety of active tamper detection techniques. In other embodiments, the active tamper detection engine 212 may comprise a single engine that performs a variety of active tamper detection techniques. The active tamper detection engine 212 may further utilize communications hardware 206 to gather data from a variety of sources (e.g., user device 106, host device 108, or the like), and/or exchange data with a user, and in some embodiments may utilize processor 202 and/or memory 204 to perform any or more of the above operations.

Further, the apparatus 200 further comprises a combination model 214 configured to receive an indication of the region of the digital document and a tampered region classification result, and then produce an overall tampering probability. The combination model 214 may utilize processor 202, memory 204, or any other hardware component included in the apparatus 200 to perform these operations, as described in connection with FIG. 3 below. The combination model 214 may further utilize communications hardware 206 to gather data from a variety of sources (e.g., user device 106, host device 108, or the like), and/or exchange data with a user, and in some embodiments may utilize processor 202 and/or memory 204 to perform any or more of the above operations.

Although components 202-214 are described in part using functional language, it will be understood that the particular implementations necessarily include the use of particular hardware. It should also be understood that certain of these components 202-214 may include similar or common hardware. For example, the tampering detection circuitry 208, passive tamper detection engine 210, active tamper detection engine 212, and combination model 214 may at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the tampering detection circuitry 208, passive tamper detection engine 210, active tamper detection engine 212, and combination model 214 may leverage processor 202, memory 204, or communications hardware 206 as described above, it will be understood that any of tampering detection circuitry 208, passive tamper detection engine 210, active tamper detection engine 212, and combination model 214 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that tampering detection circuitry 208, passive tamper detection engine 210, active tamper detection engine 212, and combination model 214 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of flowcharts.

### Example Operations

Turning to FIGS. 3-7, example flowcharts are illustrated that contain example operations implemented by example embodiments described herein. The operations illustrated in FIGS. 3-7 may, for example, be performed the tampering detection manager 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, tampering detection circuitry 208, passive tamper detection engine 210, active tamper detection engine 212, combination model 214, and/or any combination thereof. It will be understood that user interaction with the tampering detection manager 102 may occur directly via communications hardware 206, or may instead be facilitated by a separate user device 106 and/or host device 108, as shown in FIG. 1, and which may have similar or equivalent physical componentry facilitating such user interaction.

Turning first to FIG. 3, example operations are shown for detecting evidence of tampering in a digital document.

As shown by operation 302, the apparatus 200 includes means, such as communications hardware 206, or the like, for receiving a digital document. The digital document may be a computer file that contains information in a digital format. For example, a digital document may be a text document, a spreadsheet, a presentation, an image, or the like. More specifically, a digital document may be any digital document type, such as an identification document (e.g., a passport, driver's license, or the like), address proof (e.g., a utility bill, bank statements, or the like), financial statements, proof of employment, business documents, loan or credit card applications, legal documents (e.g., power of attorney), or the like.

In some embodiments, the digital document may be received by the apparatus 200 (e.g., communications hardware 206) from a computing device (e.g., user device 106, host device 108, or the like) via a network channel (e.g., communications network 104, shown in FIG. 1). For example, a user may scan a document (e.g., a physical paper document) by using the camera on a smartphone (e.g., user device 106), select a desired file format (e.g., portable document format (PDF), joint photographic experts group (JPEG), or the like), and transmit the digital document to the apparatus 200. In another example, a user may provide a document to a bank teller in a brick-and-mortar location. The bank teller may scan the document by using a computing device, such as a scanner associated with the financial institution (e.g., host device 108, or the like) and transmit the digital document to the apparatus 200. In some embodiments, the computing device that converted the document to a digital document (e.g., user device 106, host device 108, or the like) may alter the digital document. For example, a scanning app on a mobile device may adjust the brightness, contrast, crop the digital document, or the like, by default. In this regard, metadata that describes an alteration to the document that occurred during the scanning process and/or generation of the digital document may also be received by the apparatus 200.

As shown by operation 304, the apparatus 200 includes means, such as memory 204, tampering detection circuitry 208, or the like, for determining a tampered region classification result for a region of the digital document. A tampered region classification result may be a binary result that indicates if tampering is associated with a particular region of the document (e.g., the structure of a particular region, the coloring of a particular region, or the like). In some embodiments, the tampered region classification result may be influenced by the outcome of anti-tampering detection methods/techniques performed by passive tamper detection engine 210 and/or active tamper detection engine 212. In some embodiments, the tampered region classification result may be weighted to influence the overall tampering probability associated with a digital document described below in relation to operation 308.

In some embodiments a region of the digital document may be a particular portion of the digital document. For example, assume the digital document is a one-page PDF document. The one-page PDF document may be divided into any number of sections, where each section is a particular region of the digital document. Each section may be evaluated to detect evidence of tampering by passive tamper detection engine 210 and/or active tamper detection engine 212. In another example, the PDF document may comprise a single region such that the entire document is evaluated to detect evidence of tampering by passive tamper detection engine 210 and/or active tamper detection engine 212.

In some embodiments, the received digital document may be associated with a standard data template. If the received digital document is associated with a standard data template, the digital document may undergo (i) passive tamper detection methods and techniques and (ii) active tamper detection methods and techniques. The active tamper detection methods and techniques may be based on comparative analysis between the received digital document and the associated standard data template. The detailed operations describing the comparative analysis between the received digital document and associated standard data template are described below in relation to FIG. 5. However, the passive tamper detection methods and techniques do not require a standard data template. In this regard, regardless if the digital document is associated with a standard data template, passive tamper detection engine 210 may perform passive anti-tampering techniques to evaluate the digital document and, in an instance that there is not a standard data template associated with the digital document, the procedure may bypass the active tamper detection methods and techniques performed by the active tamper detection engine 212 (e.g., shown in FIG. 5) and only perform the passive anti-tamper detection methods described below in relation to FIG. 4. Turning now to FIG. 4, example operations are shown for using passive tamper detection engine 210 for detecting evidence of tampering in a digital document.

As shown by operation 402, the apparatus 200 includes means, such as memory 204, passive tamper detection engine 210, or the like, for generating a grayscale version of the digital document. The passive tamper detection engine 210 may generate a grayscale version of the digital document prior to performance of passive anti-tampering techniques to increase the efficiency of passive anti-tampering techniques by reducing noise introduced during image compression and reducing the number of channels associated with the digital document (e.g., a single channel of intensity values rather than three color channels).

In some embodiments, the passive tamper detection engine 210 may retrieve a particular algorithm associated with the color model of the digital document (e.g., RGB color model, CMYK color model, or the like) and apply a particular algorithm that converts the digital document to grayscale. For example, the passive tamper detection engine 210 may calculate the luminance value for each pixel in the received digital document. In particular, the passive tamper detection engine 210 may assign weights to particular color channels (e.g., red, green, and blue color channels for a RGB color model) to determine each particular color channels contribution to a particular grayscale value included in the converted grayscale digital document. The weights for each particular color channel may be predetermined and stored in a local storage device, such as memory 204, storage device 110, or the like.

In some embodiments, the passive tamper detection engine 210 may then remove the color components for each pixel (e.g., the red, green, and blue values for a digital document using a RGB color model), while keeping the grayscale values to generate the converted grayscale digital document. In some embodiments, the grayscale digital document may be stored in a local storage device (e.g., memory 204, storage device 110, or the like).

As shown by operation 404, the apparatus 200 includes means, such as memory 204, passive tamper detection engine 210, or the like, for extracting one or more features associated with the gray scale version of the digital document. In some embodiments, the one or more features may be associated with a particular region, where the region may be a particular segment of the grayscale version of the digital document and/or the region may be associated with the entire grayscale version of the digital document. In particular, the one or more features may describe the shading, structure, or any other characteristic of the grayscale version of the digital document (hereinafter referred to as “grayscale digital document). In some embodiments, the one or more features may describe corresponding characteristics of one or more regions of the gray scale digital document rather than of the entirety of the grayscale digital document. The features may be derived from a plurality of feature extraction processes, such as single value decomposition, double blurring correlation, image quality metric comparison, linear binary pattern analysis, or the like.

In some embodiments, the passive tamper detection engine 210 may perform a plurality of feature extraction methods/techniques to the grayscale digital document to extract one or more features from the grayscale digital document and to later determine a passive tampered region probability for a region of the digital document. In some embodiments, a passive tampered region probability may describe the probability that evidence of tampering in a digital document has been identified in response to one or more passive anti-tampering process performed by the passive tamper detection engine 210. In some embodiments, the passive tampered region probability contributes to the overall tampering probability in the form of a weighted average with other probabilities (e.g., active tampered region probability, structural similarity tampering probability, probability of authenticity, or the like) that may affect the overall tampering probability associated with a digital document.

In some embodiments, passive tamper detection engine 210 may retrieve the grayscale digital document from a local storage device (e.g., memory 204, storage device 110, or the like) and to apply the plurality of feature extraction processes. In some embodiments, the passive tamper detection engine 210 may apply single value decomposition to extract features about the grayscale digital document. Moreover, the passive tamper detection engine 210 may generate a digital document matrix, where each element in the matrix represents a particular pixel or feature of the grayscale digital document. In some embodiments, the passive tamper detection engine 210 may apply single value decomposition to the digital document matrix, which may decompose the digital document matrix into three matrices (e.g., a matrix comprising left singular vectors, a matrix comprising right singular vectors, and a matrix comprising singular values). The passive tamper detection engine 210 may subsequently reduce the dimensionality of the digital document by truncating a predetermined number of singular values and their associated right and left singular vectors. In some embodiments, the reduced dimensionality matrix comprising left singular vectors and right singular vectors include features of the grayscale digital document.

In addition, the passive tamper detection engine 210 may utilize a double blurring correlation method to extract one or more features associated with the digital document. In some embodiments, a tampered digital document may include blurring that was inserted into the digital document to conceal evidence of the tampering. The passive tamper detection engine 210 may utilize a double blurring correlation method to extract features that include evidence of tampering (e.g., blurring). The passive tamper detection engine 210 may first divide the digital document into equal non-overlapping regions. In some embodiments, the passive tamper detection engine 210 may apply two blurring operations (e.g., a Gaussian blurring filter and mean blurring filter) to each non-overlapping region. The passive tamper detection engine 210 may then calculate a double blurring similarity between corresponding regions (e.g., top left region of the Gaussian blurred digital document and top left region of the mean blurred digital document) of the blurred digital document. In some embodiments, the passive tamper detection engine 210 may extract regions of the document with a double blurring similarity below a predetermined double blurring threshold that was determined based on the evaluation of double blurring results on known authentic digital documents and known tampered digital documents.

In addition, the passive tamper detection engine 210 may utilize LBPs to extract one or more features associated with the digital document. In some embodiments, the passive tamper detection engine 210 may utilize a LBP histogram analysis to compare pixel intensity in the digital document to a pixel's respective surrounding pixels to create a binary pattern. In some embodiments, the passive tamper detection engine 210 may construct an LBP histogram that represents the distribution of LBPs within a particular small block and based on the LBP histogram, identify anomalies that may indicate evidence of tampering. Subsequently, passive tamper detection engine 210 may reference a predetermined LBP threshold, which may be stored in a storage device (e.g., memory 204) and determined based on the evaluation of LBP histograms on known authentic digital documents and known tampered digital documents, to identify anomalies within the LBP histogram. The passive tamper detection engine 210 may then extract the features and determine the region associated with the anomalies.

In addition, the passive tamper detection engine 210 may utilize image quality metric comparisons (IQM comparisons) to extract one or more features associated with the digital document. In some embodiments, the passive tamper detection engine 210 may select particular IQMs based on the grayscale digital document that describe a specific aspect of the digital document, such as sharpness, contrast, noise, or the like. In some embodiments, the passive tamper detection engine 210 may calculate each selected IQM and compare the computed IQM to predetermined image quality metric thresholds (IQM thresholds), which may be stored in a local storage device (e.g., memory 204, storage device 110, or the like) and determined based on the evaluation of IQM comparisons on known authentic digital documents and known tampered digital documents, and based on that satisfaction of the IQM thresholds, the passive tamper detection engine 210 may extract features of the digital document that do and/or do not satisfy the IQM thresholds.

In some embodiments, following the performance of the passive anti-tampering detection techniques described above, tampering detection circuitry 208 may apply a principal component analysis to the one or more features (e.g., feature vectors) obtained from each passive anti-tampering detection technique to remove a redundancy of features produced by the anti-tampering techniques and further prevent overfitting (e.g., operation 406). However, despite the benefits of preventing overfitting, tampering detection circuitry 208 may in some embodiments bypass operation 406 and proceed directly to operation 408.

As shown by operation 406, the apparatus 200 includes means, such as memory 204, tampering detection circuitry 208, or the like, for applying a principal component analysis to remove redundancy of features. A redundancy of features may describe one or more features derived from the plurality of feature extraction processes that may be omitted without meaningful loss of quality (e.g., without impacting the ability to determine a passive tampered region probability for a region of the grayscale digital document). In some embodiments, the tampering detection circuitry 208 may apply PCA to the one or more features extracted from the passive anti-tampering detection techniques described above in relation to operation 404 to investigate patterns and reduce dimensionality.

In some embodiments, the one or more features (e.g., feature vectors) may be included in a feature matrix that describes the one or more extracted features. In some embodiments, a feature matrix is associated with a particular passive anti-tampering detection technique (e.g., LBP feature matrix, double blurring feature matrix, or the like). Each matrix may be an m×n matrix, where m is the number of digital documents and n is the number of feature vectors obtained from a particular passive anti-tampering detection technique. In some embodiments, tampering detection circuitry 208 may retrieve a variety of feature vectors associated with a variety of digital documents from a storage device (e.g., memory 204) to create the feature matrices. Subsequently, the PCA may calculate a covariance matrix associated with each feature matrix that captures the relationships between the feature vectors and performs an eigenvalue decomposition that provides a set of eigenvectors (principal components) and eigenvalues (variance associated with each eigenvector). In some embodiments, the tampering detection circuitry 208 may select a particular subset of principal components to reduce dimensionality. Subsequently, the reduced dimensionality (e.g., removed redundancy) matrices may be reconstructed by projecting each feature matrix onto their respective principal components yielding a subset of features included in the subset of features matrices.

As shown by operation 408, the apparatus 200 includes means, such as memory 204, tampering detection circuitry 208, or the like, for applying a hyper plane to the subset of features to produce a detection result. In some embodiments, a support vector machine may produce the hyperplane applied to the subset of features. In some embodiments, the support vector machine (SVM) may be a supervised machine learning algorithm that classifies a subset of features included in a subset of features matrix as either indicating evidence of tampering or not indicating evidence of tampering in a digital document (e.g., a detection result).

In some embodiments, the SVM may be trained on a known subset of features derived from a set of authentic digital documents and a set of tampered digital documents. In particular, training of the SVM may produce a hyperplane from the set of authentic digital documents and the set of tampered digital documents that distinguishes between features of authentic digital documents and tampered digital documents. The hyperplane may then be used as a boundary to classify received digital documents as either authentic digital documents or tampered digital documents.

In some embodiments, tampering detection circuitry 208 may apply the hyperplane to each of the subset of features matrices to produce a detection result which classifies the subset of features matrices as either representing a digital document that has been tampered or as representing an authentic digital document. The tampering detection circuitry 208 may thereafter output the detection result. In some embodiments, the detection result may also include the distance from the hyperplane. For example, if the subset of features matrix has a detection result of “tampered”, the tampering detection circuitry 208 may output, in addition to the “tampered” detection result, an indicator of the corresponding distance from the hyperplane. FIG. 4 concludes following operation 408. If the digital document is not associated with a standard data template, the procedure may advance to operation 306. However, if a standard data template is associated with the digital document, the procedure may advance to FIG. 5.

Turning now to FIG. 5, example operations are shown for using an active tamper detection engine (e.g., active tamper detection engine 212) to detect evidence of tampering.

As shown by operation 502, the apparatus 200 includes means, such as memory 204, tampering detection circuitry 208, or the like, for determining whether the digital document is associated with a standard data template. A standard data template may be a template that describes an authentic version of a particular digital document. In some embodiments, a standard data template may comprise of the accurate colors, shading, brightness, unique digital markers (e.g., a digital signature, watermark, etc.), or the like, associated with an authentic version of a particular digital document. In some embodiments, a set of standard data templates may be stored in storage device (e.g., storage device 110, memory 204, or the like).

In some embodiments, tampering detection circuitry 208 may search the metadata associated with the received digital document and utilize the acquired metadata to filter the set of standard data templates prior to comprehensively searching the set of standard data templates. For instance, metadata describing the creation date of the document, file size, file format, document version, primary language, security settings, or the like, may be leveraged to filter the set of standard data templates. For example, assuming the digital document's primary language is Spanish, tampering detection circuitry 208 may filter all standard data templates whose primary language is not Spanish, thus saving time and computational resources for later identifying the standard data template associated with the received digital document.

In some embodiments, tampering detection circuitry 208 may search the digital document to identify the digital document type (e.g., loan application, proof of employment, or the like) and use the identified digital document type to identify the standard data template associated with the digital document. The tampering detection circuitry 208 may use any suitable techniques to identify the digital document type of the received digital document, such as optical character recognition (OCR), natural language processing (NLP), searching algorithms, machine learning models, and/or the like. In some embodiments, tampering detection circuitry 208 may OCR any data in the received digital document, if needed, and then search for an indicator of a particular digital document type. For example, tampering detection circuitry 208 may search for the title of a document (e.g., “Loan Application”, “Employee Pay Stub”, “Electric Utility Bill”, or the like), which may act as an identifier to identify the digital document type associated with the received digital document and whether that document type has a corresponding standard data template.

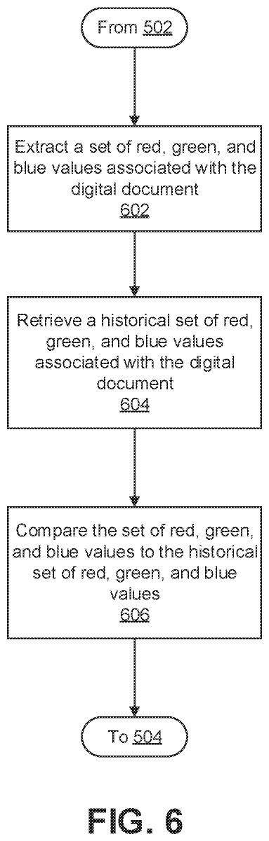

If a standard data template is not identified, the procedure advances to operation 306. Alternatively, if a standard data template is identified, the age of the digital document and any defects associated with the age of the document may be verified and/or determined through comparative analysis with the standard data template as described below in relation to FIG. 6. Turning now to FIG. 6, example operations are shown for using a digital document's historical red, green, and blue data to detect evidence of tampering.

As shown by operation 602, the apparatus 200 includes means, such as memory 204, tampering detection circuitry 208, or the like, for extracting a set of red, green, and blue values associated with the digital document. In some embodiments, the set of red, green, and blue values (herein referred to as “a set of RGB values”) refers to a set of values that represent the amount of red, green, and blue light that is used to create each pixel in an image (e.g., a digital document). Each RGB value may comprise three color channels that describe the intensity of a particular color (e.g., red, green, and blue). In particular, each color channel may be represented by an 8-bit value that ranges from 0 to 255, where 0 represents no intensity and 255 represents maximum intensity. In some embodiments, the combination of the three color channel values may describe a variety of colors and shades. For example, if a pixel has high values for the red and blue channels and a low value for the green channel, the pixel may appear to be purple.

In some embodiments, tampering detection circuitry 208 may retrieve the digital document from a storage device (e.g., storage device 110, memory 204, or the like) and/or from communications hardware 206 and subsequently read the binary data associated with the digital document. To read the digital document's binary data, tampering detection circuitry 208 may retrieve metadata associated with the digital document, such as the file format so the tampering detection engine can correctly interpret the digital documents binary data. For example, assuming the digital document is in a common image format, such as a JPEG or PNG, the tampering detection circuitry may follow the compression and encoding algorithms specific to the image format to accurately interpret the binary data associated with the digital document. Subsequently, tampering detection circuitry 208 may parse the binary data to identify characteristics about the digital document, such as the number of color channels, how the numerical values representing the colors of pixels are represented (e.g., an encoding scheme), or the like. In some embodiments, if the digital document is in RGB format, tampering detection circuitry 208 may read the data associated with the red channel, green channel, and the blue channel for each pixel and store the data as a set of RGB values associated with the digital document.

Alternatively, if the digital document uses an encoding scheme that deviates from a red, green, and blue color model, tampering detection circuitry 208 may use any suitable technique to extract the set of RGB values associated with the digital document, such as a reference table, performing a color space conversion, decoding algorithms, or the like. For example, assume the digital document is encoded using a color space that is different than RGB, such as a YUV color space. Tampering detection circuitry 208 may calculate a color space conversion that converts the set of YUV encoded values to a set of RGB values.

As shown by operation 604, the apparatus 200 includes means, such as memory 204, tampering detection circuitry 208, or the like, for retrieving the standard data template's set of red, green, and blue values (hereinafter referred to as a historical set of RGB values) associated with the digital document. A historical set of RGB values may describe a set of values that represent the amount of red, green, and blue light that is used to create each pixel in a standard data template. For example, assume the received digital document is a completed loan application. In this example, the historical set of RGB values may be a set of RGB values associated with the standard data template, where the standard data template is a digital document of the loan application that has not been edited and/or completed.

In some embodiments, the historical set of RGB values may be stored in a storage device (e.g., memory 204, storage device 110, or the like) and retrieved by tampering detection circuitry 208. In some embodiments, the historical set of RGB values may be stored in the form key-value pairs where the key portion specifies the document (e.g., author, file size, file type, creation date, parent and child document data, or the like) and the value specifies the historical set of RGB values. In some embodiments, a standard data template associated with the digital document may be stored in a storage device with no reference to a historical set of RGB values. In this regard, tampering detection circuitry 208 may retrieve the prior version of the received digital document and/or standard data template associated with the received digital document and extract and subsequently store a historical set of RGB values associated the standard data template.

As shown by operation 606, the apparatus 200 includes means, such as memory 204, tampering detection circuitry 208, or the like, for comparing the set of RGB values to the historical set of RGB values. In some embodiments, the comparison of the set of RGB values to the historical set of RGB values may produce a set of data that describes aging characteristics associated with the received document. In particular, the aging characteristics may describe the changes a document may undergo over time. For example, a 20-year-old document that is scanned and received by the apparatus 200 (e.g., communications hardware 206) may exhibit blurring, brightness changes, color reduction, or the like.

In some embodiments, tampering detection circuitry 208 may compare the set of RGB values to the historical set of RGB values. The comparison may reveal aging of the received digital document. In some embodiments, tampering detection circuitry 208 may calculate an expected age associated with the received digital document and compare the expected age to the actual age associated with the received digital document. In some embodiments, the expected age associated with the digital document may be calculated based on the comparison of the set of RGB values to the historical set of RGB values. For example, the comparison may reveal the aging characteristics associated with the digital document, such as the degree of blurring, amount of color reduction, brightness changes, or the like. The tampering detection circuitry 208, may then input the aging characteristics into a digital document aging model that outputs an expected age of the document based on the detected aging characteristics.

In some embodiments, tampering detection circuitry 208 may calculate the actual age of the received digital document. For example, tampering detection circuitry 208 may retrieve the creation date associated with the digital document and the date the digital document was submitted to the apparatus 200 (e.g., communications hardware 206) from a computing device associated with the user and/or associated with a financial institution (e.g., user device 106, host device 108, or the like) via a network (e.g., communications network 104) from a storage device (e.g., memory 204, storage device 110, or the like). The tampering detection circuitry 208 may then determine the actual age of the digital document by calculating the difference between the date the digital document was received by the apparatus 200 and the creation date of the digital document.

In some embodiments, the satisfaction of an aging threshold may be utilized to determine how the overall tampering probability is affected based on the calculated difference between the actual age of the document and the expected age of the document. For example, assume the aging threshold is predetermined and describes that the difference in the actual age of the document and the expected age of the document must be less than one year. If the difference between the actual age of the digital document and the expected age of the digital document is less than a year, the tampering detection circuitry 208 may store the aging characteristics associated with the digital document. The tampering detection circuitry 208 may store the aging characteristics in a database that includes the aging characteristics associated with digital documents in the form of key-value pairs where the key specifies a particular digital document, and the value specifies the derived aging characteristics. Alternatively, if the difference between the actual age of the digital document and the expected age of the digital document is greater than one year, the tampering detection circuitry 208 may provide an indicator to a combination model suggesting that the digital document has been tampered.

Returning to FIG. 5, as shown by operation 504, the apparatus 200 includes means, such as memory 204 active tamper detection engine 212, or the like, for determining a structural similarity index associated with the standard data template. A structural similarity index measure (SSIM) may describe a metric that is used for defining the similarity of two digital images (e.g., digital documents). In some embodiments, the structural similarity index measure is based on a comparison of a digital document to a known authentic digital document (e.g., standard data template). For example, the digital document's luminance, contrast, and structure may be compared to the authentic digital document's luminance, contrast, and structure.

In some embodiments, active tamper detection engine 212 may compute the SSIM. In some embodiments, the active tamper detection engine 212 may partition the two digital documents (the received digital document and standard data template associated with the received digital document) into small non-overlapping blocks that may be of equal and/or varying size. The active tamper detection engine 212 may then calculate the SSIM for each small block in the received digital document and the standard data template associated with the received digital document.

In some embodiments, to calculate the SSIM, the active tamper detection engine 212 may compare the luminance, contrast, and structure between the received digital document and standard data template associated with the received digital document. In some embodiments, if the active tamper detection engine 212 detects evidence of tampering (e.g., through luminance, contrast, and/or structure comparison), the active tamper detection engine 212 may retrieve the aging characteristics derived in operation 606 and verify if the aging characteristics are the cause of detected the evidence of tampering. For example, the luminance comparison may indicate evidence of tampering, however, the aging characteristics may reveal a diminished luminance based on the age of the digital document.

In some embodiments, the luminance comparison performed by the active tamper detection engine 212 is based on the digital document and standard data template associated with the digital document. For example, a grayscale image may allow the active tamper detection engine 212 to compare pixel intensities directly, however, an RGB image requires the active tamper detection engine 212 to map the set of RGB values to a different color space that accounts for luminance, such as a YUV color space. By means of continuing example, the luminance (e.g., Y in a YUV color space) in corresponding blocks between the digital document and the standard data template associated with the digital document may then be compared to measure the luminance similarity.

In addition, the contrast comparison may also be performed by the active tamper detection engine 212. For example, the active tamper detection engine 212 may calculate the local mean value for each respective block where the local mean value is the average of the pixel intensities within a particular block (e.g., the average brightness level within a particular block). The contrast comparison may further include calculating pixel intensity deviation. The pixel intensity deviation may describe how each pixel in a particular block deviates from the local mean value. For example, the active tamper detection engine 212 may calculate the difference of the local mean value and a particular pixel intensity to obtain a pixel intensity deviation value. The procedure may be repeated for each pixel included in a block of the digital document to obtain standard deviation values. In some embodiments, active tamper detection engine 212 may compare the standard deviation values associated with the digital document and the standard data template associated with the digital document to obtain the contrast similarity.

In addition, the structure comparison may also be performed by the active tamper detection engine 212. In some embodiments, the active tamper detection engine 212 may (i) generate the covariance matrix associated with the digital document and (ii) generate a covariant matrix associated with the standard data template associated with the digital document based on the pixel intensities within each block. Active tamper detection engine 212 may further analyze (e.g., compare) the generated covariance matrices to determine how pixel intensities co-vary within a particular block (e.g., a section of the digital document or section of a standard data template). The structure comparison may further include the active tamper detection engine 212 evaluating the similarity between covariant matrices associated with the same respective block (e.g., a covariant matrix derived from the digital document associated with block A and a covariant matrix derived from the standard data template associated with block A). The structure comparison may further include the active tamper detection engine 212 calculating a similarity index that describes the structural similarity between the digital document and the standard data template associated with the digital document by comparing the eigenvectors and/or eigen values of the covariant matrices.

In some embodiments, the active tamper detection engine 212 may combine the luminance similarity, contrast similarity, and structure similarity using predetermined weighting factors to calculate a SSIM value for each respective block of the digital document. The SSIM values may be averaged and/or summed using a weighted average to obtain an overall SSIM value for the digital document. In some embodiments, the satisfaction of a predetermined SSIM threshold may determine whether evidence of tampering has been identified within a particular digital document. The predetermined SSIM threshold may be determined based on analysis of known authentic digital documents and known tampered digital documents. Additionally, the active tamper detection engine 212 may reference a lookup table that describes an SSIM value with a tampered region probability stored in a storage device (e.g., memory 204) to determine the tampered region probability for each particular region (e.g., block) of the digital document with an SSIM value that satisfies the predetermined SSIM threshold. In some embodiments, the lookup table may be generated through SSIM analysis of known tampered digital documents and known authentic digital documents.

In some embodiments, the tampering detection circuitry may reference the SSIM values and the derived aging characteristics to generate a structural similarity tampering probability for each particular region. For example, the SSIM may indicate many tampered regions based on extreme values associated with the luminosity and contrast comparison; however, the aging characteristics may reveal that the received digital document is seven years old and the luminosity and contrast comparison in the SSIM is misleading as the contrast and luminosity of documents degrade over time. In this regard, the structural similarity tampering probability may account for aging characteristics.

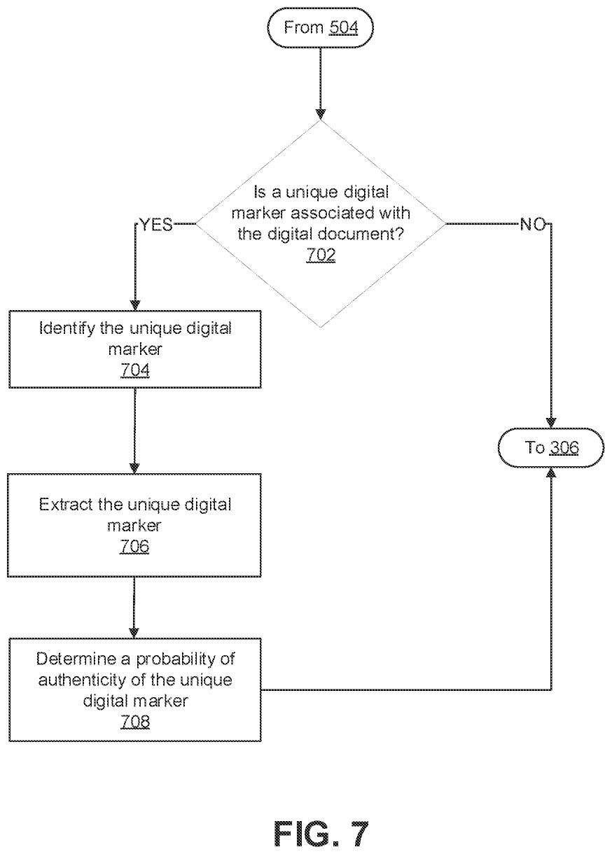

In some embodiments, the digital document may not include a unique digital marker, in which case the procedure advances to operation 306 following determination of the structural similarity index. However, if a unique digital marker is embedded within a digital document and/or the standard data template, the procedure advances to FIG. 7. Turning now to FIG. 7, example operations are shown for using a unique digital marker to detect evidence of tampering.

As shown by operation 702, the apparatus 200 includes means, such as memory 204, tampering detection circuitry 208, or the like, for determining whether a unique digital marker is associated with the digital document. A unique digital marker may be a security mechanism that is embedded in a digital document to increase the reliability and integrity of the digital document. In some embodiments, the unique digital marker may be a digital signature or a digital watermark that is embedded in the digital document.

In some embodiments, the expected presence of a unique digital marker may be indicated in a database (e.g., in a storage device, such as memory 204, storage device 110, or the like) that stores the standard data templates. For example, the database may store the standard data template and a unique digital marker status that indicates if a unique digital marker is associated with the standard data template and what type of unique digital marker is associated with the standard data template (e.g., digital watermark, digital signature, or the like). Further, the database may store the standard data template and unique digital marker status in the form of key-value pairs where the key specifies the standard data template, and the value specifies the unique digital marker status.

In some embodiments, the tampering detection circuitry 208 may query the database to determine if a unique digital marker is expected to be associated with the digital document. For example, tampering detection circuitry 208 may query the database (e.g., a database located in memory 204, storage device 110, or the like) and search for the key associated with the standard data template that is associated with the received digital document to obtain the unique digital marker status associated with the standard data template. If a unique digital marker is expected to be associated with the digital document, then the procedure advances to operation 704. Alternatively, if a unique digital marker is not expected to be associated with the digital document, the procedure may advance to operation 306 and bypass the steps for processing unique digital markers outlined in connection with the remaining operations set forth in FIG. 7.

As shown by operation 704, the apparatus 200 includes means, such as memory 204, tampering detection circuitry 208, or the like, for identifying a unique digital marker. In some embodiments, tampering detection circuitry 208 may retrieve from a storage device (e.g., memory 204) metadata associated with the standard data template. The metadata may describe the particular watermarking scheme used (e.g., spread spectrum watermarks, frequency domain water marks, spatial domain watermarks, or the like) to embed a unique digital marker (e.g., a watermark) in the standard data template. In this regard, tampering detection circuitry 208, may retrieve instructions from a storage device to identify presence of a unique digital marker associated with a particular unique digital marker scheme. For example, spatial domain watermarking embeds a watermark into a digital document by changing the intensity and color value of pixels. By means of continuing example, tampering detection circuitry 208 may then search the digital document for changes in intensity and color values of pixels to identify the unique digital marker.

As shown by operation 706, the apparatus 200 includes means, such as tampering detection circuitry 208, or the like, for extracting the unique digital marker. In some embodiments, tampering detection circuitry 208 may apply various algorithms and techniques to extract the unique digital marker from the digital document for analysis. For example, assume the presence of a digital watermark was identified in the standard data template, tampering detection circuitry 208 may utilize a principal component analysis whitening (PCA whitening) process to extract the digital watermark from the digital document. By means of continuing example, the PCA whitening process may begin by applying principal component analysis (PCA) to the digital document and extracting the principal components associated with the digital document. The principal components may then be transformed to a new space where the components are uncorrelated and have unit variance (e.g., the whitening process). In some embodiments, the transformed principal components may then be analyzed to identify the principal components that include the digital marker (e.g., the principal components may have higher values in the regions where the digital marker is present).

Additionally, or alternatively, the unique digital marker status may indicate presence of a digital signature. In some embodiments, tampering detection circuitry 208 may identify the location of the digital signature based on the signing mechanism or the file format. For example, a PDF may store the digital signature within a defined signature field and/or a separate signature block. Tampering detection circuitry 208 may employ an extraction algorithm associated with the particular signing mechanism that isolates the region of the document that includes the digital signature for extraction. Further, tampering detection circuitry 208 may utilize the extraction algorithm to extract data about the digital signature, such as cryptographic data (e.g., signed hash value, timestamps, or the like).

As shown by operation 708, the apparatus 200 includes means, such as memory 204, tampering detection circuitry 208, or the like, for determining a probability of authenticity of the unique digital marker. A probability of authenticity may describe the authenticity of a digital document based on the authenticity of a unique digital marker. In some embodiments, the tampering detection circuitry 208 may determine the probability of authenticity based on an evaluation of the unique digital marker. In some embodiments, evaluation of the unique digital marker may be based on the unique digital marker type (e.g., digital watermark, digital signature, or the like).

In some embodiments, tampering detection circuitry 208 may evaluate a digital watermark based on a similarity score that indicates the similarity between the digital watermark embedded in the received digital document and the digital watermark embedded in the standard data template. Tampering detection circuitry 208 may perform the same extraction operation as described in operation 702 on the standard data template to extract the digital watermark for comparison to the received digital watermark. Alternatively, tampering detection circuitry 208 may retrieve the digital watermark associated with a standard data template from a storage device (e.g., memory 204, storage device 110, or the like).

Tampering detection circuitry 208 may use any suitable technique to determine a similarity score between the received digital watermark and the watermark associated with the standard data template, such as template matching (e.g., pixel-level matching between the received digital watermark and the watermark associated with the standard data template), machine learning models (e.g., machine learning algorithms trained to recognize and match watermarks), statistical analysis techniques (e.g., pixel intensity, texture features, or the like), or the like.

In addition, tampering detection circuitry 208 may use a variety of methods/techniques to determine a similarity score associated with a digital signature. The method may include obtaining a public key associated with the received digital document. For example, the tampering detection circuitry 208 may leverage communications hardware 206 to retrieve the public key from a trusted source (e.g., a certificate authority, or the like). The tampering detection circuitry 208 may then attempt to verify the signature using the obtained public key, and may generate a probability of authenticity based on whether the verification was successful (or not).

Returning to FIG. 3, as shown by operation 306, the apparatus 200 includes means, such as memory 204, communications hardware 206, tampering detection circuitry 208, combination model 214, or the like, for providing an indication of the region of the digital document and the tampered region classification result to combination model 214. In some embodiments, combination model 214 may be a machine learning model that combines one or more partial tampering probabilities and/or tampering classification results, such as a tampered region classification result, passive tampered region probability, detection result, active tampered region probability, aging characteristics, probability of authenticity, structural similarity tampering probability, or the like, to produce an overall tampering probability, which accounts for the results from a plurality of anti-tampering techniques. In some embodiments, the combination model may have predetermined weights for each of the partial tampering probabilities. The predetermined weights may be determined by training the combination model on a set of data obtained from passive and active anti-tampering detection techniques performed on tampered and authentic documents.

In some embodiments, that tampering detection circuitry 208 may retrieve from a local storage device (e.g., memory 204, storage device 110, or the like) the partial tampering probabilities associated with the received digital document and transmit the partial tampering probabilities to the combination model. In some embodiments, the combination model may return the overall tampering probability associated with the received digital document to the tampering detection circuitry 208, and may additionally, or alternatively, store the overall tampering probability in a local storage device of (or accessible by) the apparatus 200.

As shown by operation 308, the apparatus 200 includes means, such as memory 204, communications hardware 206, combination model 214, or the like, for receiving the overall tampering probability. In some embodiments, the tampering detection circuitry 208 may retrieve and/or receive the overall tampering probability from combination model 214. In some embodiments, however, combination model 214 may receive an indication of each region of the digital document and a plurality of corresponding tampered region probabilities (e.g., partial tampering probabilities), and may generate respective tampering probabilities for each region. The tampering detection circuitry 208 may thereafter combine the overall tampering probabilities for each region to produce the overall tampering probability for the digital document.

In some embodiments, the tampering detection circuitry 208 may determine a tampering confidence result associated with the digital document based on the overall tampering probability. The tampering confidence result may categorize the digital document into a predefined category, such as tampered document, likely tampered document, not likely tampered document, not tampered document. In some embodiments, each predefined category may be associated with a tampering threshold, where the tampering threshold is associated with the overall tampering probability. For example, an overall tampering probability between 0.5 and 0.7 may be assigned a tampering confidence result of likely tampered. In some embodiments, the confidence result may trigger predetermined actions (e.g., actions determined by an entity, such as a financial institution to secure an entities resources, reputation, and/or the like in the event that evidence of tampered digital documents has occurred and been identified).

After determining a confidence result that indicates evidence of tampering in a digital document, tampering detection circuitry 208 may automatically store the tampered digital document in a storage device (e.g., memory 204, storage device 110, or the like) to preserve the tampered digital document and prevent further loss of information. In addition, the entity (e.g., a financial institution) that is evaluating digital documents for evidence of tampering may open an investigation to identify the parties involved in the tampering, implement containment measures to prevent additional damage caused from the tampered documents, and/or determine any necessary disciplinary actions for the identified parties involved.

An entity's ability to identify evidence of tampering in digital documents may allow the entity to mitigate risks associated with fraud. In addition, tampered documents may have legal and regulatory implications, thus identifying evidence of tampering may mitigate legal risks. Finally, entities committed to identifying tampering in digital documents may help an entity maintain their reputation for a commitment to security.

FIGS. 3, 4, 5, 6, and 7 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable an improved ability to detect evidence of tampering in digital documents. Example embodiments thus provide tools that overcome the problems faced by sophisticated tampering techniques that avoid detection by a singular anti-tampering method. By combining an ensemble of passive detection and active detection techniques into a single result, example embodiments produce highly accurate anti-tampering detection results that have historically not been available. Moreover, embodiments described herein avoid problems faced with analyzing digital documents with a unique digital marker (e.g., a digital watermark, digital signature, or the like) by automatically processing and analyzing the unique digital marker.

As these examples all illustrate, example embodiments contemplated herein provide technical solutions that solve real-world problems faced while detecting evidence of tampering in digital documents. And while detecting evidence of tampering in digital documents has been an issue for decades, the recently exploding amount of data made available by recently emerging technology today has made this problem significantly more acute, as the demand for detecting evidence of tampering in digital documents has grown significantly, more and more areas of society leverage computerized solutions that process digital documents, so the need to ensure accuracy of those digital documents is growing substantially given the collectively larger downstream impact, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for detecting evidence of tampering in a digital document, the method comprising:
receiving, by communications hardware, the digital document;
determining, by a tampering detection circuitry, a tampered region classification result for a region of the digital document;
in an instance in which the tampered region classification result indicates tampering, providing, by the tampering detection circuitry, an indication of the region of the digital document and the tampered region classification result to a combination model; and
receiving, by the tampering detection circuitry, an overall tampering probability from the combination model.

2. The method of claim 1, wherein determining the tampered region classification result includes:
determining, by a passive tamper detection engine, a passive tampered region probability for the region of the digital document,
wherein the tampered region classification result for the region of the digital document is based on the passive tampered region probability.

3. The method of claim 2, wherein determining the passive tampered region probability comprises:
generating, by the passive tamper detection engine, a grayscale version of the digital document;
extracting, by the passive tamper detection engine, one or more features associated with the grayscale version of the digital document;
applying, by the tampering detection circuitry and using the one or more features, a principal component analysis to remove redundancy of features, wherein applying the principal component analysis generates a subset of features; and
applying, by the tampering detection circuitry and based on the principal component analysis, a hyperplane to the subset of features to produce a detection result, wherein the passive tampered region probability is based on the detection result.

4. The method of claim 3, wherein extracting the one or more features comprises:
performing, by the tampering detection circuitry, a plurality of feature extraction processes, wherein the plurality of feature extraction processes comprises single value decomposition, double blurring correlation, image quality metric comparison, or linear binary pattern histogram analysis.

5. The method of claim 1, wherein determining the tampered region classification result includes:
determining, by the tampering detection circuitry, whether the digital document is associated with a standard data template; and
in an instance in which the digital document is associated with the standard data template, determining, by an active tamper detection engine, an active tampered region probability for the region of the digital document,
wherein the tampered region classification result for the region of the digital document is based on the active tampered region probability.

6. The method of claim 5, wherein determining the active tampered region probability further comprises:
extracting, by the tampering detection circuitry, a set of red, green, and blue values associated with the digital document;
retrieving, by the tampering detection circuitry, a historical set of red, green, and blue values associated with the digital document; and
comparing, by the tampering detection circuitry, the set of red, green, and blue values associated with the digital document to the historical set of red, green, and blue values to produce aging characteristics in the digital document, wherein the overall tampering probability is based on the aging characteristics.

7. The method of claim 5, wherein, in an instance in which the digital document is associated with the standard data template, determining the active tampered region probability further comprises:
determining whether a unique digital marker is associated with the digital document; and
in an instance in which the unique digital marker is associated with the digital document:
identifying, by the tampering detection circuitry, the unique digital marker,
extracting, by the tampering detection circuitry, the unique digital marker,
determining, by the tampering detection circuitry and using the standard data template, a probability of authenticity of the unique digital marker, and
determining, by the tampering detection circuitry, the overall tampering probability based on the probability of authenticity of the unique digital marker.

8. The method of claim 5, further comprises, in an instance in which the digital document is associated with the standard data template:
determining, by the tampering detection circuitry, a structural similarity index associated with the digital document and the standard data template; and
generating, by the tampering detection circuitry and based on the structural similarity index, a structural similarity tampering probability associated with the digital document, wherein the overall tampering probability is based on the structural similarity tampering probability.

9. The method of claim 1, further comprising:
determining, by the tampering detection circuitry and based on the overall tampering probability, a tampering confidence result, wherein the tampering confidence result is based on a tampering threshold.

10. An apparatus for detecting evidence of tampering in a digital document, the apparatus comprising:
communications hardware configured to receive the digital document; and
a tampering detection circuitry configured to:
determine a tampered region classification result for a region of the digital document;
in an instance in which the tampered region classification result satisfies a predetermined threshold, provide an indication of the region of the digital document and the tampered region classification result to a combination model; and
receive an overall tampering probability from the combination model.

11. The apparatus of claim 10, wherein the tampering detection circuitry is further configured to:
determine by a passive tamper detection engine, a passive tampered region probability for the region of the digital document,
wherein the tampered region classification result for the region of the digital document is based on the passive tampered region probability.

12. The apparatus of claim 11, wherein the tampering detection circuitry is further configured to:
generate by the passive tamper detection engine, a grayscale version of the digital document;
extract, by the passive tamper detection engine, one or more features associated with the grayscale version of the digital document;
apply, the one or more features, a principal component analysis to remove redundancy of features, wherein the principal component analysis generates a subset of features; and
apply, based on the principal component analysis, a hyperplane to the subset of features to produce a detection result, wherein the passive tampered region probability is based on the detection result.

13. The apparatus of claim 10, wherein the tampering detection circuitry is further configured to:
determine whether the digital document is associated with a standard data template; and
in an instance in which the digital document is associated with the standard data template, determine, by an active tamper detection engine, an active tampered region probability for the region of the digital document,
wherein the tampered region classification result for the region of the digital document is based on the active tampered region probability.

14. The apparatus of claim 13, wherein the tampering detection circuitry is further configured to:
extract a set of red, green, and blue values associated with the digital document;
retrieve a historical set of red, green, and blue values associated with the digital document; and
compare the set of red, green, and blue values associated with the digital document to the historical set of red, green, and blue values to produce aging characteristics in the digital document, wherein the overall tampering probability is based on the aging characteristics.

15. The apparatus of claim 13, wherein the tampering detection circuitry is further configured to:
determine a structural similarity index associated with the digital document and the standard data template; and
generate, based on the structural similarity index, a structural similarity tampering probability associated with the digital document, wherein the overall tampering probability is based on the structural similarity tampering probability.

16. A non-transitory computer-readable storage medium storing instructions that, when executed by an apparatus, cause the apparatus to:
receive a digital document;
determine a tampered region classification result for a region of the digital document;
in an instance in which the tampered region classification result satisfies a predetermined threshold, provide an indication of the region of the digital document and the tampered region classification result to a combination model; and
receive an overall tampering probability from the combination model.

17. The non-transitory computer-readable storage medium of claim 16, wherein the instructions, when executed by the apparatus, further cause the apparatus to:
determine a passive tampered region probability for the region of the digital document,
wherein the tampered region classification result for the region of the digital document is based on the passive tampered region probability.

18. The non-transitory computer-readable storage medium of claim 17, wherein the instructions, when executed by the apparatus, further cause the apparatus to:
generate a grayscale version of the digital document;
extract one or more features associated with the grayscale version of the digital document;
apply, using the one or more features, a principal component analysis to remove redundancy of features, wherein the principal component analysis generates a subset of features; and
apply, based on the principal component analysis, a hyperplane to the subset of features to produce a detection result, wherein the passive tampered region probability is based on the detection result.

19. The non-transitory computer-readable storage medium of claim 16, wherein the instructions, when executed by the apparatus, further cause the apparatus to:
determine whether the digital document is associated with a standard data template; and
in an instance in which the digital document is associated with the standard data template, determine, by an active tamper detection engine, an active tampered region probability for the region of the digital document,
wherein the tampered region classification result for the region of the digital document is based on the active tampered region probability.

20. The non-transitory computer-readable storage medium of claim 19, wherein the instructions, when executed by the apparatus, further cause the apparatus to:
extract a set of red, green, and blue values associated with the digital document;
retrieve a historical set of red, green, and blue values associated with the digital document; and
compare the set of red, green, and blue values associated with the digital document to the historical set of red, green, and blue values to produce aging characteristics in the digital document, wherein the overall tampering probability is based on the aging characteristics.
